(19) United States
(12) Patent Application Publication
(10) Pub. No.: US 2019/0204659 A1
(43) Pub. Date: Jul. 4, 2019

(54) LIQUID CRYSTAL PANEL PACKAGE COMPONENT

(71) Applicant: HUIZHOU CHINA STAR OPTOELECTRONICS TECHNOLOGY CO., LTD., Huizhou Guangdong (CN)

(72) Inventor: Yunping WANG, Huizhou Guangdong (CN)

(21) Appl. No.: 15/952,458

(22) Filed: Apr. 13, 2018

Related U.S. Application Data
(63) Continuation of application No. PCT/CN2018/074286, filed on Jan. 26, 2018.

(30) Foreign Application Priority Data
Jan. 3, 2018 (CN) 201810005636.3

(51) Int. Cl. G02F 1/1333

(52) U.S. Cl. CPC G02F 1/133308; G02F 2201/46; G02F 2001/133317

(57) ABSTRACT

The present disclosure discloses a liquid crystal package component including a box and a buffer member, wherein a limiting groove is formed on the inner wall of a bezel of the box, the buffer member includes a fixing portion and a buffer portion connected to one end of the fixing portion, the fixing portion is detachably disposed in the limiting groove, the buffer portion is disposed at the corner of the inner wall of the bezel, and the buffer portion abuts the liquid crystal panel accommodated in the box. According to the liquid crystal panel package component disclosed in the present disclosure, a limiting groove is provided in the interior of the box, and the buffer member is detachably disposed in the limiting groove. Under the premise of the stable connection between the buffer member and the box, the buffer member can be conveniently disassembled.

### RELATED APPLICATIONS

The present application is a Continuation Application of International Application No. PCT/CN20181074286, filed Jan. 26, 2018, and claims the priority of China Application No. 201810005636.3, filed Jan. 3, 2018, which is herein incorporated by reference in its entirety.

### FIELD OF THE DISCLOSURE

The present disclosure relates to a liquid crystal panel packaging technology field, and more particularly to a liquid crystal panel package component.

### BACKGROUND OF THE DISCLOSURE

In the field of liquid crystal panel packaging, the inside of the box is generally provided with a plug retaining wall, the plug retaining walls are arranged on the four corners of the inner wall of the box, and the better protection of the liquid crystal panel is achieved through the cooperation of the box and the plug retaining wall. Existing plug retaining wall plugged in the box when the general use of double-sided adhesive or glue fixed to prevent plug retaining wall shedding. However, due to the plug retaining wall is non-removable, when the box is damaged or the plug retaining wall is damaged, the entire packaging device will be scrapped, which is not conducive to the recovery of the intact parts.

### SUMMARY OF THE DISCLOSURE

The technical problem to be solved by the present disclosure is to overcome the shortcomings of the prior art and to provide a liquid crystal panel package component with simple structure and easy disassembly.

In order to achieve the above object, the present disclosure adopts the following technical solutions.

A liquid crystal package component includes a box and a buffer member, wherein a limiting groove is formed on the inner wall of a bezel of the box, the buffer member includes a fixing portion and a buffer portion connected to one end of the fixing portion, the fixing portion is detachably disposed in the limiting groove, the buffer portion is disposed at the corner of the inner wall of the bezel, and the buffer portion abuts the liquid crystal panel accommodated in the box.

Optionally, the buffer member further includes an elastic layer, the elastic layer is disposed on the surface of the fixing portion facing away from the inner wall of the bezel, and the elastic layer elastically abuts the inner wall of the limiting groove; the end of the limiting groove near the inner wall of the bezel is provided with a blocking portion, and the blocking portion abuts the surface of the fixing portion facing the inner wall of the bezel.

Optionally, the buffer member further includes an extending portion bent from the end of the fixing portion away from the inner wall of the bezel, the side wall of the limiting groove is provided with a recessed portion, and the extending portion is inserted into the recessed portion.

Optionally, the number of the extending portions is two, and two of the extending portions are disposed on two opposite sides of the fixing portion.

Optionally, the surface of the extending portion facing away from the inner wall of the bezel is flush with the surface of the fixing portion facing away from the inner wall of the bezel, both ends of the elastic layer extend to the surface of the extending portion facing away from the inner wall of the bezel.

Optionally, the elastic layer includes a plurality of elastic strips arranged at intervals.

Optionally, the buffer portion includes a first buffer portion bent from one end of the fixing portion near the inner wall of the bezel and a second buffer portion formed by bending one end of the first buffer portion, the first buffer portion abuts on the inner wall of the bezel and the second buffer portion abuts on the other inner wall of the bezel connected to the inner wall of the bezel.

Optionally, the buffer member further includes a first flexible layer and a second flexible layer, the first flexible layer is attached to the surface of the first buffer portion facing away from the inner wall of the bezel, and the second flexible layer is attached to the surface of the second buffer portion facing away from the inner wall of the bezel.

Optionally, the liquid crystal panel package component further includes a first locking member, the first buffer portion and/or the second buffer portion is provided with a first through hole, the first locking member penetrates through the first through hole, and the first locking member locks the first buffer portion and/or the second buffer portion on the inner wall of the bezel.

Optionally, the liquid crystal package component further includes a second locking member, the box further includes a bottom plate connected to the bezel, the buffer member further includes a locking portion, the locking portion is simultaneously connected to the end of the first buffer portion near the bottom plate and the end of the second buffer portion near the bottom plate; the locking portion is provided with a second through hole, the second locking portion penetrates through the second through hole, and the locking portion is locked on the bottom plate.

According to the liquid crystal panel package component disclosed in the present disclosure, a limiting groove is provided in the interior of the box, and the buffer member is detachably disposed in the limiting groove. Under the premise of the stable connection between the buffer member and the box, the buffer member can be conveniently disassembled to facilitate the replacement or recycling of the buffer member and the utilization rate.

### BRIEF DESCRIPTION OF THE DRAWINGS

FIG. 1 is a schematic diagram of a liquid crystal panel package component according to Embodiment 1 of the present disclosure.

FIG. 2 is a partial enlarged diagram of a liquid crystal panel package component according to Embodiment 1 of the present disclosure.

FIG. 3 is a schematic diagram of a buffer member according to Embodiment 1 of the present disclosure.

FIG. 4 is a partial enlarged diagram of a liquid crystal panel package component according to Embodiment 2 of the present disclosure.

FIG. 5 is a partial enlarged diagram of a liquid crystal panel package component according to Embodiment 3 of the present disclosure.

### DETAILED DESCRIPTION OF PREFERRED EMBODIMENTS

In order to make the objectives, technical solutions and advantages of the present disclosure more comprehensible, the present disclosure is further described in detail below with reference to the accompanying drawings and embodiments. It should be understood that the specific embodiments described herein are merely used to explain the present disclosure, and are not intended to limit the present disclosure.

### Embodiment 1

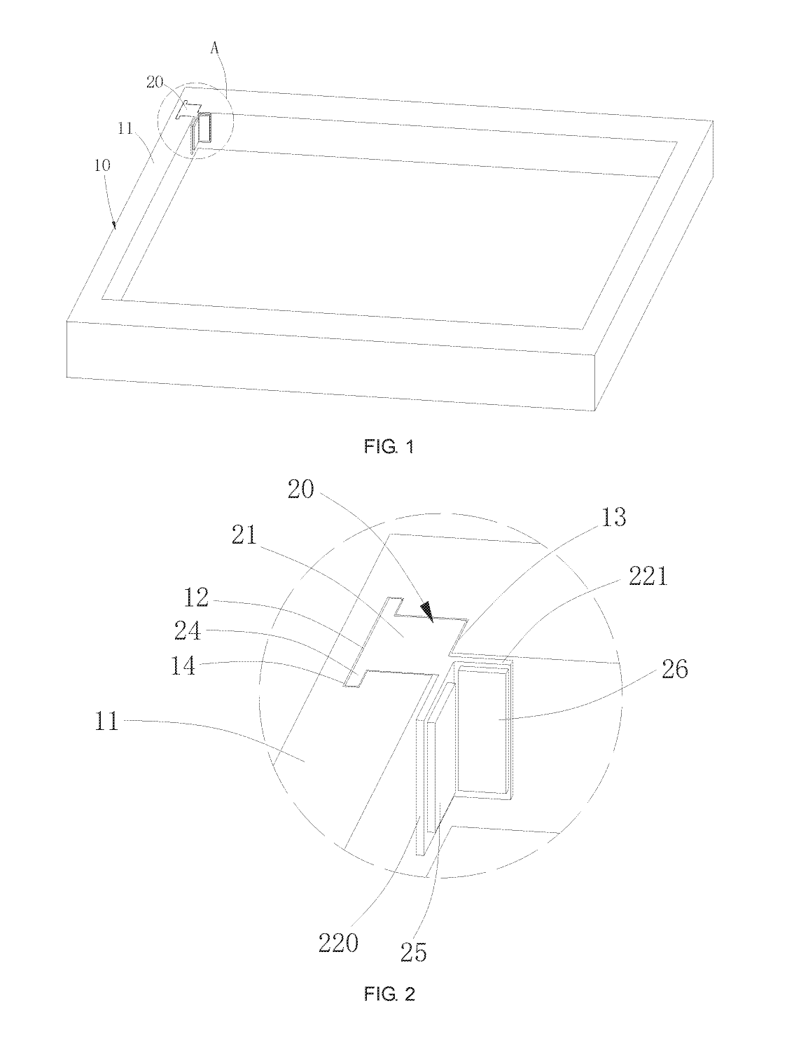

As shown in FIG. 1 and FIG. 2, the liquid crystal package component of the present embodiment including a box 10 and a buffer member 20, wherein a limiting groove 12 is formed on the inner wall of a bezel 11 of the box 10, the buffer member 20 includes a fixing portion 21 and a buffer portion 22 connected to one end of the fixing portion 21, the fixing portion 21 is detachably disposed in the limiting groove 12, the buffer portion 22 is disposed at the corner of the inner wall of the bezel 11, and the buffer portion 22 abuts the liquid crystal panel accommodated in the box 10. On one hand, the buffer member 20 is stably fixed on the box 10 through the cooperation of the fixing portion 21 and the limiting groove 12; on the other hand, since the buffer member 20 is detachable, the replacement of the new buffer member 20 is facilitated when the buffer member 20 is damaged or the good buffer member 20 is conveniently recovered when the box is damaged.

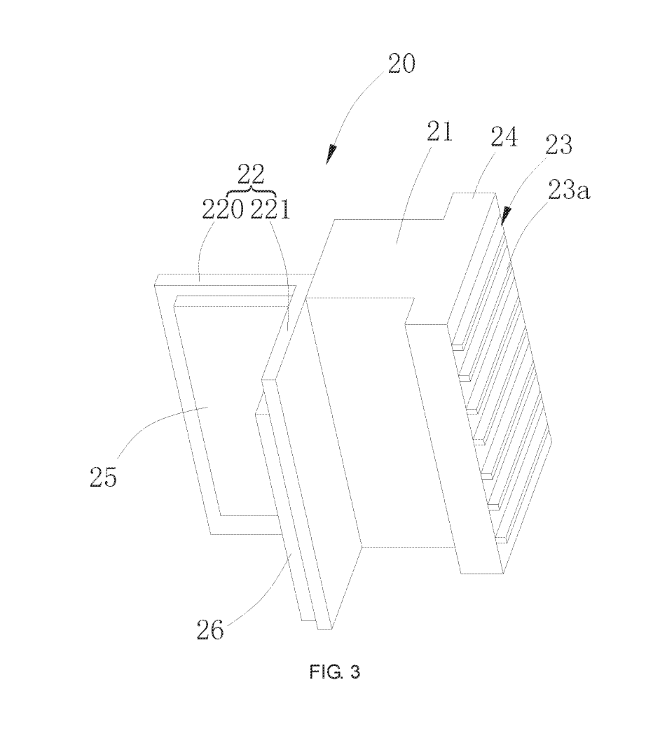

As a preferred embodiment, as shown in FIG. 3, the buffer member 20 further includes an elastic layer 23 disposed on the surface of the fixing portion 21 facing away from the inner wall of the bezel 11 and elastically resiliently contacting with the inner wall of the limiting groove 12. At one end of the limiting groove 12 close to the inner wall of the bezel 11, a blocking portion 13 is provided. The blocking portion 13 abuts on the surface of the fixing portion 21 facing the inner wall of the bezel. In this way, the two ends of the fixing portion 21 are limited to achieve a stable connection to the fixing portion 21, By the elastic action of the elastic layer 23, the connection between the fixing portion 21 and the limiting groove 12 is made more compact. In addition, the elastic layer 23 is provided to facilitate the attachment and detachment of the buffer member 20.

Specifically, the buffer member 20 further includes an extending portion 24 bent from the end of the fixing portion 21 away from the inner wall of the bezel 11. The side wall of the limiting groove 12 is provided with a recessed portion 14. The extending portion 24 is inserted into the recessed portion 14 to further improve the connection stability between the fixing portion 21 and the limiting groove 12 and prevent the buffer member from falling off, As a preferred embodiment, the number of the extending portions 24 is two, and two extending portions 24 are disposed on two opposite sides of the fixing portion 21. Of course, in other embodiments, the number of the extending portions 24 may be other.

Further, the surface of the extending portion 24 facing away from the inner wall of the bezel 11 is flush with the surface of the fixing portion 21 facing away from the inner wall of the bezel 11. The two ends of the elastic layer 23 extend to the surface of the extending portion 24 facing away from the inner wall of the bezel 11. So that the buffer member 20 to be more tightly connected to the box.

As a preferred embodiment, the elastic layer 23 includes a plurality of elastic strips 23a arranged at intervals, In this way, in the case that the elastic layer 23 and the inner wall of the limiting groove 12 are ensured to be in close contact with each other, the contact area between the elastic layer 23 and the limiting groove 12 is reduced, so as to reduce the frictional resistance between the elastic layer 23 and the inner wall of the limiting groove 12 so as to facilitate the installation and removal of the buffer member 20. Of course, in other embodiments, the elastic layer 23 may further include a plurality of elastic columns distributed in rows and columns, The material of the elastic layer 23 is preferably rubber.

Specifically, the buffer portion 22 includes a first buffer portion 220 formed by bending one end of the fixing portion 21 close to the inner wall of the bezel 11, and a second buffer portion 221 formed by bending one end of the first buffer portion 220. The first buffer portion 220 and the second buffer portion 221 are perpendicular to each other. The first buffer portion 220 abuts on the inner wall of the bezel 11 and the second buffer portion 221 abuts on the other inner wall of the bezel 11 vertically connected to the inner wall of the bezel 11, so as to prevent the corners of the liquid crystal panel directly contacting the corners of the inner wall of the bezel 11.

Further, the buffer member 20 further includes a first flexible layer 25 and a second flexible layer 26. The first flexible layer 25 is adhered to the surface of the first buffer portion 220 facing away from the inner wall of the bezel 11, the second flexible layer 26 is attached to the surface of the second buffer portion 221 facing away from the inner wall of the bezel 11, the first flexible layer 25 and the second flexible layer 26 directly contact the edge of the liquid crystal panel to achieve better protection of the liquid crystal panel.

### Embodiment 2

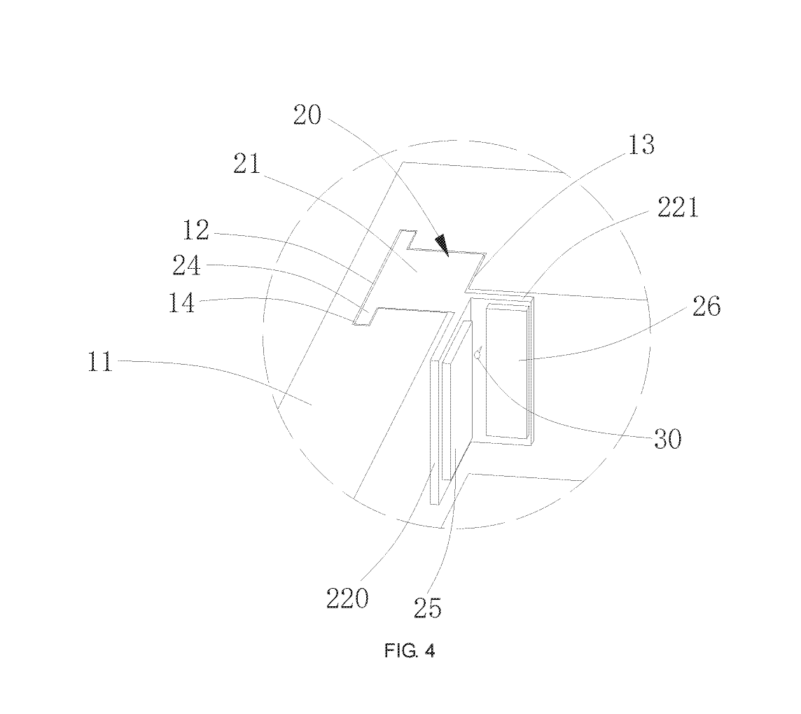

As shown in FIG. 4, the difference between Embodiment 2 and Embodiment 1 is that the liquid crystal panel package component further includes a first locking member 30. A first through hole is formed in the first buffer portion 220 or the second buffer portion 221, the first locking member 30 passes through the first through hole, and the first locking member 30 locks the first buffer portion 220 or the second buffer portion 221 on the inner wall of the bezel 11. In this way, the connection between the buffer member 20 and the box 10 is more compact, and the first locking member 30 is easily disassembled, which facilitates the disassembly of the buffer member 20. The first locking member 30 can be a self-tapping screw.

Of course, in other embodiments, the first buffer portion 220 and the second buffer portion 221 are provided with the first through holes at the same time, so that the first locking member 30 can simultaneously lock the first buffer portion 220 and the second buffer portion 221 on the bezel 11.

### Embodiment 3

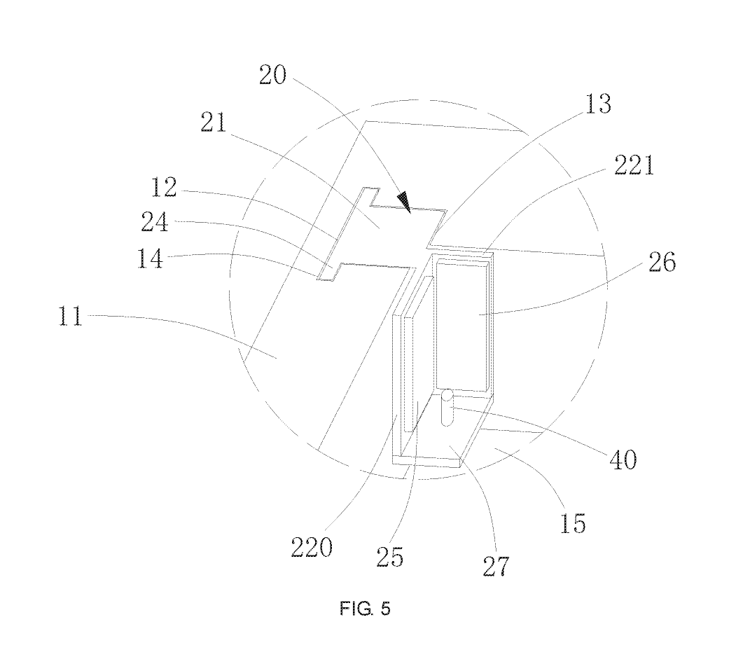

As shown in FIG. 5, the difference between Embodiment 3 and Embodiment 1 is that the liquid crystal package component further includes a second locking member 40. The box 10 further includes a bottom plate 13 connected to the bezel 11. The buffer member 20 further includes a locking portion 26. The locking portion 26 is simultaneously connected to the end of the first buffer portion 220 close to the bottom plate 13 and the end of the second buffer portion 221 close to the bottom plate 13. The locking portion 26 defines a second through hole therein, the second locking member 40 penetrates through the second through hole, and locks the locking portion 26 on the bottom plate 13. In this way, the buffer member 20 is more tightly connected to the box 10, and the second locking member 40 is easily disassembled, which facilitates the disassembly of the buffer member 20. The second locking member 40 may be a stud.

According to the liquid crystal panel package assembly disclosed in the present disclosure, a limiting groove is provided in the interior of the box, and the buffer member is detachably disposed in the limiting groove. Under the premise of the stable connection between the buffer member and the box, the buffer member can be conveniently disassembled to facilitate the replacement or recycling of the buffer member and the utilization rate.

While specific embodiments of the present disclosure have been described in detail, some embodiments have been shown and described. It will be understood by those skilled in the art that, these embodiments may be modified and improved without departing from the spirit and scope of the present disclosure as defined by the claims and their equivalents, and such modifications and improvements should also fall within the protection scope of the present disclosure.

What is claimed is:

1. A liquid crystal package component, comprising a box and a buffer member, wherein a limiting groove is formed on an inner wall of a bezel of the box, the buffer member comprises a fixing portion and a buffer portion connected to one end of the fixing portion, the fixing portion is detachably disposed in the limiting groove, the buffer portion is disposed at a corner of the inner wall of the bezel, and the buffer portion abuts a liquid crystal panel accommodated in the box.

2. The liquid crystal package component according to claim 1, wherein the buffer member further comprises an elastic layer, the elastic layer is disposed on a surface of the fixing portion facing away from the inner wall of the bezel, and the elastic layer elastically abuts the inner wall of the limiting groove; an end of the limiting groove near the inner wall of the bezel is provided with a blocking portion, and the blocking portion abuts a surface of the fixing portion facing the inner wall of the bezel.

3. The liquid crystal package component according to claim 2, wherein the buffer member further comprises an extending portion bent from an end of the fixing portion away from the inner wall of the bezel, the side wall of the limiting groove is provided with a recessed portion, and the extending portion is inserted into the recessed portion.

4. The liquid crystal package component according to claim 3, wherein a number of the extending portions is two, and two of the extending portions are disposed on two opposite sides of the fixing portion.

5. The liquid crystal package component according to claim 4, wherein a surface of the extending portion facing away from the inner wall of the bezel is flush with the surface of the fixing portion facing away from the inner wall of the bezel, both ends of the elastic layer extend to the surface of the extending portion facing away from the inner wall of the bezel.

6. The liquid crystal package component according to claim 2, wherein the buffer portion comprises a first buffer portion bent from one end of the fixing portion near the inner wall of the bezel and a second buffer portion formed by bending one end of the first buffer portion, the first buffer portion abuts on the inner wall of the bezel and the second buffer portion abuts on the other inner wall of the bezel connected to the inner wall of the bezel.

7. The liquid crystal package component according to claim 6, wherein the buffer member further comprises a first flexible layer and a second flexible layer, the first flexible layer is attached to a surface of the first buffer portion facing away from the inner wall of the bezel, and the second flexible layer is attached to a surface of the second buffer portion facing away from the inner wall of the bezel.

8. The liquid crystal package component according to claim 6, wherein the liquid crystal panel package component further comprises a first locking member, the first buffer portion and/or the second buffer portion is provided with a first through hole, the first locking member penetrates through the first through hole, and the first locking member locks the first buffer portion and/or the second buffer portion on the inner wall of the bezel.

9. The liquid crystal package component according to claim 6, wherein the liquid crystal package component further comprises a second locking member, the box further comprises a bottom plate connected to the bezel, the buffer member further comprises a locking portion, the locking portion is simultaneously connected to an end of the first buffer portion near the bottom plate and an end of the second buffer portion near the bottom plate; the locking portion is provided with a second through hole, the second locking portion penetrates through the second through hole, and the locking portion is locked on the bottom plate.

10. The liquid crystal package component according to claim 2, wherein the elastic layer comprises a plurality of elastic strips arranged at intervals.

11. The liquid crystal package component according to claim 10, wherein the buffer portion comprises a first buffer portion bent from one end of the fixing portion near the inner wall of the bezel and a second buffer portion formed by bending one end of the first buffer portion, the first buffer portion abuts on the inner wall of the bezel and the second buffer portion abuts on the other inner wall of the bezel connected to the inner wall of the bezel.

12. The liquid crystal package component according to claim 11, wherein the buffer member further comprises a first flexible layer and a second flexible layer, the first flexible layer is attached to a surface of the first buffer portion facing away from the inner wall of the bezel, and the second flexible layer is attached to a surface of the second buffer portion facing away from the inner wall of the bezel.

13. The liquid crystal package component according to claim 11, wherein the liquid crystal panel package component further comprises a first locking member, the first buffer portion and/or the second buffer portion is provided with a first through hole, the first locking member penetrates through the first through hole, and the first locking member locks the first buffer portion and/or the second buffer portion on the inner wall of the bezel.

14. The liquid crystal package component according to claim 11, wherein the liquid crystal package component further comprises a second locking member, the box further comprises a bottom plate connected to the bezel, the buffer member further comprises a locking portion, the locking portion is simultaneously connected to an end of the first buffer portion near the bottom plate and an end of the second buffer portion near the bottom plate; the locking portion is provided with a second through hole, the second locking portion penetrates through the second through hole, and the locking portion is locked on the bottom plate.
